(19) United States
(12) Patent Application Publication
(10) Pub. No.: US 2026/0056711 A1
(43) Pub. Date: Feb. 26, 2026

(54) CONVOLUTION OPERATION DEVICE

(71) Applicant: SigmaStar Technology Ltd., Xiamen (CN)

(72) Inventors: Houyu WANG, Shanghai (CN); Xiaofeng LI, Shanghai (CN); Chengwei ZHENG, Shanghai (CN)

(21) Appl. No.: 19/290,550

(22) Filed: Aug. 5, 2025

(30) Foreign Application Priority Data
Aug. 23, 2024 (CN) 202411169933.3

(51) Int. Cl. G06F 7/523; G06F 7/50

(52) U.S. Cl. CPC G06F 7/523; G06F 7/50

(57) ABSTRACT

A convolution operation device includes a multiply-accumulate (MAC) circuit and a post-processing circuit. The MAC circuit performs a convolution operation according to first feature data and a weight coefficient to generate initial operation data and generates a completion signal. The post-processing circuit obtains a first shift value from a memory according to the completion signal, performs a bit shift on the initial operation data according to the first shift value to generate shifted operation data, and performs a first clipping operation on the shifted operation data according to a predetermined value range to generate first operation data, wherein the number of bits of the first operation data is less than the number of bits of the initial operation data.

This application claims the benefit of China application Serial No. CN202411169933.3, filed on Aug. 23, 2024, the subject matter of which is incorporated herein by reference.

### BACKGROUND OF THE INVENTION

### Field of the Invention

The present application relates to a convolution operation device, and more particularly to a convolution operation device able to reduce circuit implementation costs.

### Description of the Related Art

A convolution operation device is often used to implement a neural network so as to realize various types of recognition applications. In current applications, a processing circuit in a convolution operation device needs to process an operation result generated by a multiply-accumulate (MAC) circuit to generate a final output. Because the number of bits of an operation result generated by a MAC circuit is usually quite large, a processing circuit also needs to support a larger input bit width in order to completely receive and process the operation result. Thus, overall costs of the processing circuit are significantly increased.

### SUMMARY OF THE INVENTION

In some embodiments, it is an object of the present application to provide a convolution operation circuit able to reduce circuit implementation costs so as to improve the issues of the prior art.

In some embodiments, a convolution operation device includes a multiply-accumulate (MAC) circuit and a post-processing circuit. The MAC circuit performs a convolution operation according to first feature data and a weight coefficient to generate initial operation data and generates a completion signal. The post-processing circuit obtains a first shift value from a memory according to the completion signal, performs a bit shift on the initial operation data according to the first shift value to generate shifted operation data, and performs a first clipping operation on the shifted operation data according to a predetermined value range to generate first operation data, wherein the number of bits of the first operation data is less than the number of bits of the initial operation data.

Features, implementations and effects of the present application are described in detail in preferred embodiments with the accompanying drawings below.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 is a schematic diagram of a convolution operation device according to some embodiments of the present application.

FIG. 2 is a schematic diagram of the post-processing circuit in FIG. 1 according to some embodiments of the present application.

FIG. 3 is a flowchart of operations of the post-processing circuit in FIG. 2 according to some embodiments of the present application.

FIG. 4 is a flowchart of operations for generating the shift value in FIG. 1 or FIG. 2 according to some embodiments of the present application.

FIG. 5 is a schematic diagram of an operation for generating FIG. 4 according to some embodiments of the present application.

### DETAILED DESCRIPTION OF THE INVENTION

All terms used in the literature have commonly recognized meanings. Definitions of the terms in commonly used dictionaries and examples discussed in the disclosure of the present application are merely exemplary, and are not to be construed as limitations to the scope or the meanings of the present application. Similarly, the present application is not limited to the embodiments enumerated in the description of the application.

The term “coupled” or “connected” used in the literature refers to two or multiple elements being directly and physically or electrically in contact with each other, or indirectly and physically or electrically in contact with each other, and may also refer to two or more elements operating or acting with each other. As given in the literature, the term “circuit” may be a device connected by at least one transistor and/or at least one active element by a predetermined means so as to process signals.

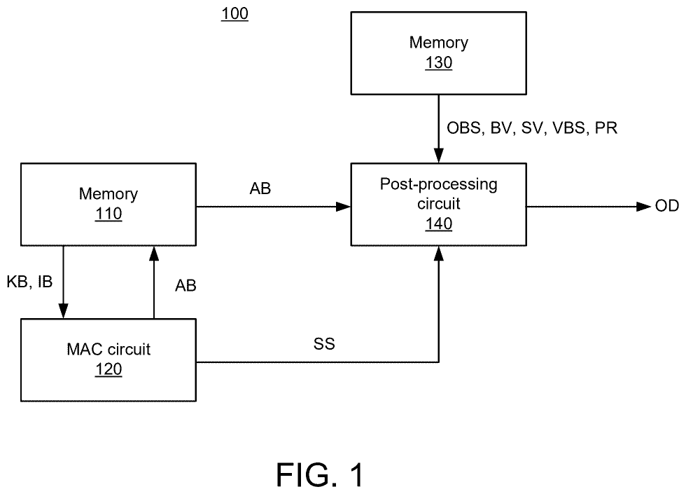

FIG. 1 shows a schematic diagram of a convolution operation device 100 according to some embodiments of the present application. The convolution operation device 100 includes a memory 110, a multiply-accumulate (MAC) circuit 120, a memory 130 and a post-processing circuit 140. In some embodiments, each of the memory 110 and the memory 130 may be, for example but not limited to, a static random access memory (SRAM).

The MAC circuit 120 performs a convolution operation according to feature data IB and a weight coefficient KB to generate initial operation data AB, stores the initial data AB to the memory 110, and accordingly generates a completion signal SS. In some embodiments, the feature data IB may be input feature data, for example but not limited to, image data and voice data. In some embodiments, the feature data IB and the weight coefficient KB may also be stored in the memory 110. The memory 130 may have multiple pre-configured shift values OBS, bias values BV, scale values SV and shift values VBS stored therein. The multiple parameters above are provided to the post-processing circuit 140 to process the initial operation data AB. Configuration details associated with the parameters above are to be described shortly below. It is understandable that, the memory 110 and the memory 130 may be combined and configured as one memory, which stores the feature data IB, weight coefficient KB, the initial operation data AB, the multiple shift values OBS, the multiple bias values BV, the multiple scale values SV and the multiple shift values VBS above.

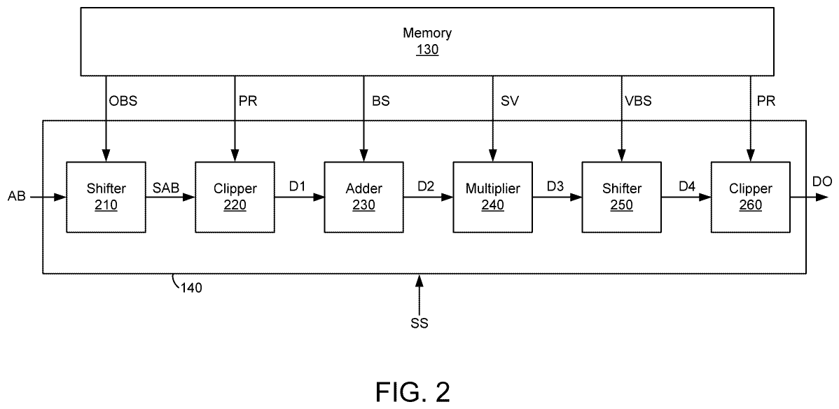

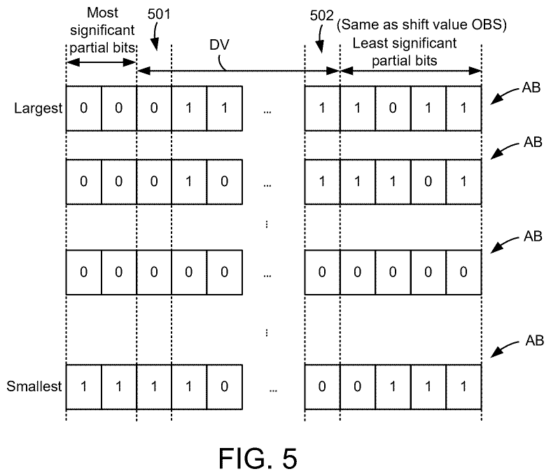

The post-processing circuit 140 obtains the initial operation data AB from the memory 110 according to the completion signal SS, and obtains the corresponding shift value OBS, bias value VB, scale value SV and shift value VBS from the memory 130. Next, the post-processing circuit 140 may perform a bit shift on the initial operation data AB according to the corresponding shift value OBS to generate shifted operation data (for example, shifted operation data SAB in FIG. 2), and perform a clipping operation on the shifted operation data according to a predetermined value range PR to generate first operation data (for example, operation data D1 in FIG. 2). With the clipping operation above, it is ensured that the number of bits of the first operation data is less than the number of bits of each of the initial operation data AB and the shifted operation data. For example, the number of bits of each of the initial operation data AB and the shifted operation data may be 48, and the number of bits of the first operation data is 16. It should be noted that numerical values of the numbers of bits above are merely examples, and the present application is not limited to such examples. Details associated with the clipping operation are to be described with reference to FIG. 5 below. In different embodiments, information of the predetermined value range PR may be stored in the memory 130, or may be stored in a register (not shown) in the post-processing circuit 140.

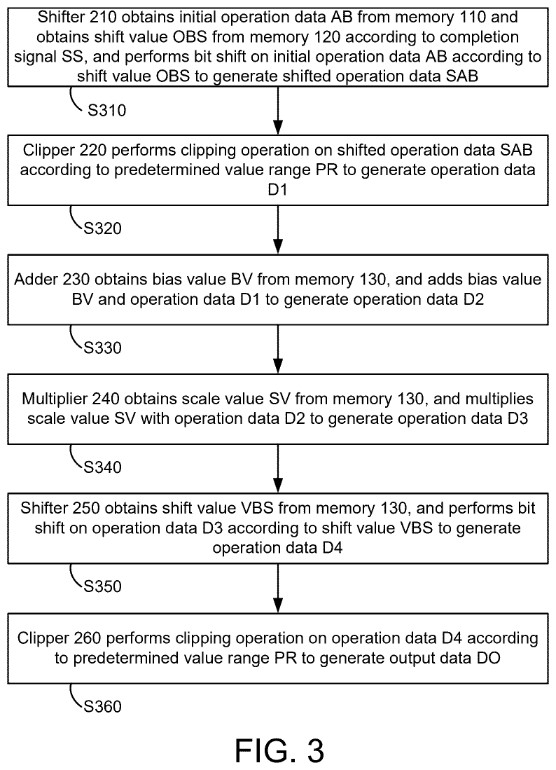

Further, the post-processing circuit 140 may add the bias value VB and the first operation data to generate second operation data (for example, operation data D2 in FIG. 2), and multiply the scale value SV with the second operation data to generate third operation data (for example, operation data D3 in FIG. 2). Lastly, the post-processing circuit 140 may perform a shift on the third operation data according to the shift value VBS to generate fourth operation data (for example, operation data D4 in FIG. 2), and perform a clipping operation on the fourth operation data according to the predetermined value range PR to generate output data DO. In some embodiments, the post-processing circuit 140 may store the output data DO in a memory (not shown). Configuration and operation details associated with the post-processing circuit 140 are to be described below with reference to FIG. 2 and FIG. 3 below.

FIG. 2 shows a schematic diagram of the post-processing circuit 140 in FIG. 1 according to some embodiments of the present application. FIG. 3 shows a flowchart of operations of the post-processing circuit 140 in FIG. 2 according to some embodiments of the present application. The post-processing circuit 140 includes a shifter 210, a clipper 220, an adder 230, a multiplier 240, a shifter 250 and a clipper 260. In some embodiments, each of the multiple units above in the post-processing circuit 140 may be implemented by a register circuit, a digital circuit and/or a logical circuit. For the sake of better description, operations of the multiple units above are to be described with reference to FIG. 3 below.

In operation S310, the shifter 210 obtains the initial operation data AB from the memory 110 and obtains the shift value OBS from the memory 130 according to the completion signal SS, and performs a bit shift on the initial operation data AB according to the shift value OBS to generate the shifted operation data SAB. For example, the initial operation data AB may include 48 bits, and the value of the shift value OBS is m. Thus, the shifter 210 may shift the 48 bits in the initial operation data AB to the right by m bits, and output the bits having been shifted to the right as the operation data SAB, wherein the value m may be a non-negative integer (including 0).

In operation S320, the clipper 220 performs a clipping operation on the shifted operation data SAB according to the predetermined value range PR to generate the operation data D1. In some embodiments, the predetermined value range PR may be determined according to a bandwidth of a quantization scenario in actual applications. For example, if the number of bits of the initial operation data AB is 16, the predetermined value range PR may bet set to [−32767, 32767] according to this number of bits, of which an upper limit is 32767 and a lower limit is −32767. If the value of the shifted operation data SAB is located within the predetermined value range PR, the clipper 220 may output the shifted operation data SAB as first sub-data. Alternatively, if the value of the shifted operation data SAB exceeds the upper limit (for example, 32767) of the predetermined value range PR or is lower than the lower limit (for example, −32767) of the predetermined value range PR, the clipper 220 may set the corresponding one of the upper limit and the lower limit as the first sub-data. For example, if the value of the sifted operation data SAB exceeds 32767, the clipper 220 may set data corresponding to the upper limit 32767 as the first sub-data above. On the other hand, if the value of the sifted operation data SAB is lower than −32767, the clipper 220 may set data corresponding to the lower limit −32767 as the first sub-data above. With the operation above, undesired bit overflow errors in subsequent operation processes may be prevented, hence improving the accuracy of overall operation. Further, the clipper 220 may output partial bits in the first sub-data as the operation data D1. Associated details herein are to be described with reference to FIG. 5 below. In some embodiments, the clipper 220 may be implemented by, for example, but not limited to, a comparator circuit or a selector circuit.

In operation S330, the adder 230 obtains the bias value BV from the memory 130, and adds the bias value VB and the operation data D1 to generate operation data D2. In operation S340, the multiplier 240 obtains the scale value SV from the memory 130, and multipliers the scale value SV with the operation data D2 to generate the operation data D3. In operation S350, the shifter 130 obtains the shift value VBS from the memory 130, and performs a bit shift on the operation data D3 according to the shift value VBS to generate the operation data D4. Similar to operation S310, the shifter 250 may shift multiple bits of the operation data D3 to the right according to the shift value VBS, and output the multiple bits having been shifted as the operation data D4.

In operation S360, the clipper 260 may perform a clipping operation on the operation data D4 according to the predetermined value range PR to generate the output data DO. Similar to operation S320, the clipper 260 may perform a clipping operation on the operation data D4 according to the predetermined value range PR to generate second sub-data, and output partial bits of the second sub-data as the output data DO.

In some related art, a convolution operation device directly performs a convolution on input feature map data. In this case, a storage data size of a memory and an input bit width of a post-processing circuit (for example, a multiplier) in the convolution operation device need to support input feature map data having a greater number of bits. For example, if the number of bits of input feature map data is 48, each of the storage data size of the memory and the input bit width of the multiplier needs to be at least 48-bit. Similarly, in these related art, other circuits in a post-processing circuit also need to be configured as operation circuits able to process data having large numbers of bits. Thus, the overall circuit area may become overly large, leading to overly high circuit costs.

Compared to the related art above, in some embodiments of the present application, with the corresponding shift value OBS configured in advance in an offline phase by a corresponding convolution operator, the convolution operation device 100, upon receiving the operation data AB, may perform a bit shift on the initial operation data AB to generate the operation data D1 according to the shift value OBS and the predetermined value range PR (corresponding to a quantization range of an application scenario), so that the number of bits of the operation data D1 can be less than the number of bits of the initial operation data AB. As such, complexities and required bit widths of other circuits in the post-processing circuit 140 can be reduced, thereby reducing the overall circuit area and costs. For example, if the number of bits of the initial operation data AB is 48, the number of bits of the operation data D1 having undergone the bit shift and clipping operation is 16, and the input bit width of the adder 230 can then be accordingly reduced to 16 bits, which is significantly lower than the number of bits of the initial operation data AB.

It should be understood that, for the sake of clear and simple representation, FIG. 2 depicts only the post-processing circuit 140 corresponding to one single channel. In actual applications, the convolution operation device 100 may include multiple parallel post-processing circuits 140 which respectively correspond to multiple channels in a neural network, and each of these channels may be used to generate the corresponding output data DO by using the corresponding initial operation data AB. In some embodiments, the post-processing circuit 140 corresponding to each channel may obtain the shift value OBS, the bias value VB, the scale value SV and the shift value VBS corresponding to this channel from the memory 130. In some embodiments, the set of circuits corresponding to each channel is for executing an operator in a neural network executed by the post-processing circuit 140. Thus, in some embodiments, the shift value OBS, the bias value VB, the scale value SV and the shift value VBS used by each channel may be generated in advance in an offline phase by the neural network executed by the post-processing circuit 140 and sample data.

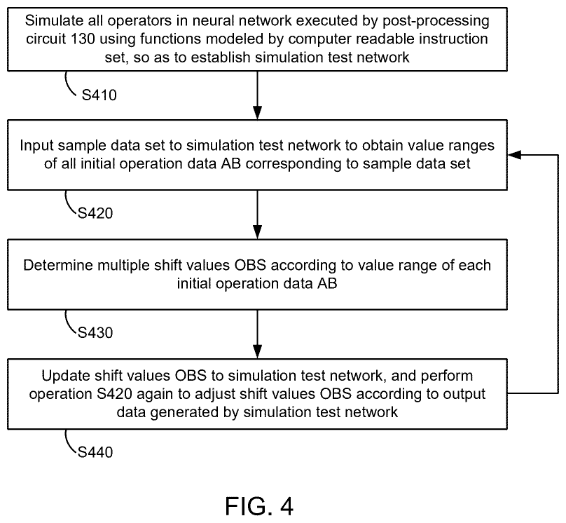

FIG. 4 shows a flowchart of operations for generating the shift value OBS in FIG. 1 or FIG. 2 according to some embodiments of the present application. In some embodiments, the multiple processes in FIG. 4 may be implemented in an offline phase (for example but not limited to, a circuit design phase or a circuit measurement phase), and may be performed by a machine or a computer executing a chip design tool or circuit simulation software.

In operation S410, all operators in the neural network executed by the post-processing circuit 140 are simulated using functions modeled by a computer readable instruction set, so as to establish a simulation test network. In some embodiments, the instruction set is established by C language; however, the present application is not limited to the example above. In operation S420, the sample data set is input to the simulation test network to obtain value ranges of all initial operation data AB corresponding to the sample data set. In some embodiments, the sample data set is sample data established in advance. For example, if the neural network executed by the post-processing circuit 140 is applied to vehicle image recognition, the sample data set may be data of multiple images established in advance, and the contents thereof may be common scenarios associated with vehicle image recognition. It should be noted that the type of the sample data set above is merely an example, and the present application is not limited thereto. In operation S430, multiple shift values OBS are determined according to the value range of each initial operation data AB. In operation S440, the shift values OBS are updated to the simulation test network, and then return to the operation S420, the operation S420 to operation S430 are again performed successively to adjust the shift values OBS according to the output data generated by the simulation test network. Thus, by repeating the multiple operations above, multiple shift values OBS able to provide accurate image recognition results (equivalent to accurate output data DO) can be determined.

FIG. 5 shows a schematic diagram for generating operation S430 in FIG. 4 according to some embodiments of the present application. In operation S430, the value ranges of all initial operation data AB corresponding to the sample data set may be obtained. A most significant bit of the initial operation data AB is multiple extended bits of a sign bit. More specifically, if bit 501 is a sign bit, all bits higher than bit 501 are extended bits of the sign bit. Taking the largest initial operation data AB for example, bit 501 is a logical bit 0, which means that the initial operation data AB is a positive value, and extended bits higher than bit 501 are all logical value 0. Similarly, taking the smallest initial operation data AB or example, bit 501 is a logical bit 1, which means that the initial operation data AB is a negative value, and extended bits higher than bit 501 are all logical value 1. Moreover, the least significant bit of the initial operation data AB is set to all bits between the next bit of bit 502 and the least significant bit, and may be the number of deletable bits. That is, the number of bits of the least significant bit is the shift value OBS.

In other words, the shift value OBS identified by the training process above allows all bits between bit 501 and bit 502 to be valid data DV in the initial operation data AB, and effectively reduces the total number of bits and provides valid contents with sufficient accuracy. Thus, the valid data DV shown in FIG. 5 is equivalent to the shifted operation data SAB generated in operation S310 in FIG. 3. In operation S320, as described above, the post-processing circuit 140 may process the shifted operation data SAB according to the predetermined value range PR to generate the first sub-data, and output corresponding partial bits (equivalent to the valid data DV and a part thereof in FIG. 5) in the first sub-data as the operation data D1. That is, the post-processing circuit 140 may delete the most significant partial bit and the least significant partial bit from the shifted operation data SAB by a clipping operation, thereby obtaining the shifted operation data SAB. The post-processing circuit 140 may perform operation S350 by a similar method to generate the operation data D4. It should also be noted that, in some embodiments, during an execution process in practice, the actual number of bits of the valid data DV may also be less than a predetermined number of data bits (for example, 16 bits above). In this case, the shift value OBS may be set to 0.

Similarly, in some embodiments, during an offline phase, the bias value VB may be obtained by operations of: representing an original bias value of a neural network as a fixed-point number; performing a bit shift on the original bias value according to the shift value OBS to generate the bias value BV; if the bias value BV is located within a predetermined value range (for example, the predetermined value range PR above), keeping the bias value VB unchanged; if the bias value BV exceeds an upper limit of the predetermined value range, setting the bias value BV as the upper limit; and if the bias value BV is less than a lower limit of the predetermined value range, setting the bias value BV as the lower value. Similarly, once value ranges of all of the initial operation data AB are obtained, the operation above may be further used to configure multiple corresponding bias values BV according to multiple shift values OBS.

Similarly, in some embodiments, during an offline phase, the scale value SV and the shift value VBS may be obtained by operations of: estimating an original scale value and an original shift value by a mathematical model of an original neural network; setting the original scale value as the scale value SV; and subtracting the shift value OBS from the original shift value to generate the shift value VBS.

The related operation details for generating the shift value OBS, the bias value BV, the scale value SB and the shift value VBS described above are merely examples, and various related operations able to perform a clipping operation on input data of a post-processing circuit and generation means in an offline manner are to be encompassed within the scope of the present application. For example, in the various examples above, the bit shift is exemplified by shifting to the right; however, the present application is not limited to the examples above. In other embodiments, the bit shift above may also be shifting to the left according to actual application requirements.

In conclusion, the convolution operation device provided according to some embodiments of the present application is able to configure multiple operations in advance in an offline phase so as to perform shift and clipping operations on an input of a post-processing circuit. Thus, while ensuring the accuracy of output data, the space needed in a memory as well as an input bit width needed in a subsequent circuit in a processing circuit are further reduced, thereby lowering overall circuit costs.

While the present application has been described by way of example and in terms of the preferred embodiments, it is to be understood that the disclosure is not limited thereto. Various modifications may be made to the technical features of the present application by a person skilled in the art on the basis of the explicit or implicit disclosures of the present application. The scope of the appended claims of the present application therefore should be accorded with the broadest interpretation so as to encompass all such modifications.

What is claimed is:

1. A convolution operation device, comprising:
a multiply-accumulate (MAC) circuit, performing a convolution operation according to first feature data and a weight coefficient to generate initial operation data, and generating a completion signal; and
a post-processing circuit, obtaining a first shift value from a memory according to the completion signal, performing a bit shift on the initial operation data according to the first shift value to generate shifted operation data, and performing a first clipping operation on the shifted operation data according to a predetermined value range to generate first operation data, wherein the number of bits of the first operation data is less than the number of bits of the initial operation data.

2. The convolution operation device according to claim 1, wherein the post-processing circuit performs the first clipping operation according to the predetermined value range to generate sub-data, and outputs a corresponding partial bit of the sub-data as the first operation data.

3. The convolution operation device according to claim 2, wherein if the shifted operation data exceeds an upper limit of the predetermined value range or is less than a lower limit of the predetermined value range, the post-processing circuit sets data corresponding to the upper limit or the lower limit as the sub-data.

4. The convolution operation device according to claim 2, wherein if the shifted operation data is within the predetermined value range, the post-processing circuit outputs the shifted operation data as the sub-data.

5. The convolution operation device according to claim 2, wherein the post-processing circuit deletes a most significant partial bit and a least significant partial bit from the sub-data to obtain the corresponding partial bit, the most significant partial bit of the sub-data is a plurality of extended bits corresponding to a sign bit in the sub-data, and the number of bits of the least significant partial bit is the first shift value.

6. The convolution operation device according to claim 1, wherein the first shift value is generated in an offline phase by a neural network executed by the post-processing circuit and a sample data set.

7. The convolution operation device according to claim 1, wherein the post-processing circuit further obtains a bias value from the memory according to the completion signal, and adds the bias value and the first operation data to generate second operation data.

8. The convolution operation device according to claim 7, wherein the post-processing circuit comprises an adder, the adder adds the bias value and the first operation data to generate the second operation data, and an input bit width of the adder is less than the number of bits of the initial operation data.

9. The convolution operation device according to claim 7, wherein the post-processing circuit further obtains a scale value from the memory according to the completion signal, and multiplies the scale value by the second operation data to generate third operation data.

10. The convolution operation device according to claim 9, wherein the post-processing circuit further obtains a second shift value from the memory according to the completion signal, performs a shift on the third operation data according to the second shift value to generate fourth operation data, and performs a second clipping operation on the fourth operation data according to the predetermined value range to generate output data.
